(19) United States
(12) Patent Application Publication
(10) Pub. No.: US 2019/0172366 A1
(43) Pub. Date: Jun. 6, 2019

(54) SYSTEMS AND DEVICES TO FACILITATE SAVINGS OF MONEY BASED ON ALLOWANCE AND CHORES

(71) Applicants: Andrew John Birt, Wilston (AU); Jason Ko, Melbourne (AU)

(72) Inventors: Andrew John Birt, Wilston (AU); Jason Ko, Melbourne (AU)

(21) Appl. No.: 16/211,032

(22) Filed: Dec. 5, 2018

Related U.S. Application Data
(60) Provisional application No. 62/594,860, filed on Dec. 5, 2017.

(51) Int. Cl. G09B 19/00; G06Q 20/10

(52) U.S. Cl. CPC G09B 19/00; G06Q 20/065; G06Q 20/108

(57) ABSTRACT

A system for facilitating management of chores is disclosed. The system may include a communication device configured for receiving chore data from a parent device, transmitting the chore data to a child device, receiving operational data from at least one electrical appliance associated with the chore data, transmitting chore status data corresponding to the at least one chore to the parent device, and transmitting account data corresponding to at least one child account to the child device. Further, the system may include a processing device configured for analyzing the chore data and the operational data, generating the chore status data based on the analyzing, determining at least one reward based on the chore status data, and updating the account data based on the at least one reward. Further, the system may include a storage device configured for storing the chore data, the chore status data and the account data.

### FIELD OF THE INVENTION

The present disclosure generally relates to the field of electronic devices. More specifically, the present disclosure relates to a device, a system and a method to facilitate savings of money based on allowance and chores.

### BACKGROUND OF THE INVENTION

Methods to transfer money have grown exponentially with advancements in Internet technologies. Additionally, individuals may now manage their savings in banks through their smartphones and computers over the internet.

Further, systems to link savings accounts to digital money boxes also exist. These money boxes are capable of displaying the savings made in the linked bank accounts. Additionally, to store physical currency, money boxes like piggy banks have been in use since time immemorial. However, present systems may not allow for a combination of both the aforementioned systems, along with proposing chores and rewards to earn additional monetary compensation and increase savings.

Therefore, there is a need for improved systems and devices to facilitate savings of money based on Chores that may overcome one or more of the above-mentioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

A system for facilitating management of chores is disclosed. The system may include a communication device configured for receiving chore data corresponding to at least one chore from a parent device. Further, the communication device may be configured for transmitting the chore data to a child device. Further, the communication device may be configured for receiving operational data from at least one electrical appliance associated with the chore data. Further, the communication device may be configured for transmitting chore status data corresponding to the at least one chore to the parent device. Further, the communication device may be configured for transmitting account data corresponding to at least one child account to the child device. Further, the system may include a processing device configured for analyzing the chore data and the operational data. Further, the processing device may be configured for generating the chore status data based on the analyzing. Further, the processing device may be configured for determining at least one reward based on the chore status data. Further, the processing device may be configured for updating the account data based on the at least one reward. Further, the system may include a storage device configured for storing the chore data, the chore status data and the account data.

A method for facilitating management of chores is also disclosed. The method may include receiving, using a communication device, chore data corresponding to at least one chore from a parent device. Further, the method may include transmitting, using the communication device, the chore data to a child device. Further, the method may include receiving, using the communication device, operational data from at least one electrical appliance associated with the chore data. Further, the method may include analyzing, using a processing device, the chore data and the operational data. Further, the method may include generating, using the processing device, chore status data based on the analyzing. Further, the method may include transmitting, using the communication device, the chore status data corresponding to the at least one chore to the parent device. Further, the method may include determining, using the processing device, at least one reward based on the chore status data. Further, the method may include updating, using the processing device, account data corresponding to at least one child account based on the at least one reward. Further, the method may include storing, using a storage device, the chore data, the chore status data and the account data. Further, the method may include transmitting, using the communication device, the account data corresponding to at least one child account to the child device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 shows a system for facilitating management of chores, in accordance with some embodiments.

FIG. 3 shows a smart money box, in accordance with some embodiments.

FIG. 4 shows a flowchart of a method for facilitating management of chores, in accordance with some embodiments.

FIG. 5 shows a flowchart of a method for generating chore analytics, in accordance with some embodiments.

FIG. 6 shows a flowchart of a method for transmitting a chore recommendation, in accordance with some embodiments.

FIG. 7 shows an exemplary system to facilitate savings of money based on chores and/or a periodic allowance, in accordance with some embodiments.

FIG. 8 shows a method of facilitating savings of money based on chores and/or periodic allowances including receiving account data associated with a user from a bank server and transmitting the account data to a Smart Money Box, in accordance with some embodiments.

FIG. 9 shows a method of facilitating savings of money based on chores and/or periodic allowance including recommending periodic allowance, chores and/or monetary rewards based on chore data received from at least one of a plurality of Smart Money Boxes and a plurality of user devices, in accordance with some embodiments.

FIG. 10 shows a flowchart of a method of facilitating savings of money based on chores including sending a notification based on operational data received from smart appliances, in accordance with some embodiments.

FIG. 11 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of savings of money based on Chores and/or periodic allowances, embodiments of the present disclosure are not limited to use only in this context. For example, the Smart Money Box may be used for saving money for different purposes such as “college tuition fee”, “buying a vehicle”, “a vacation”, “periodic allowance” etc.

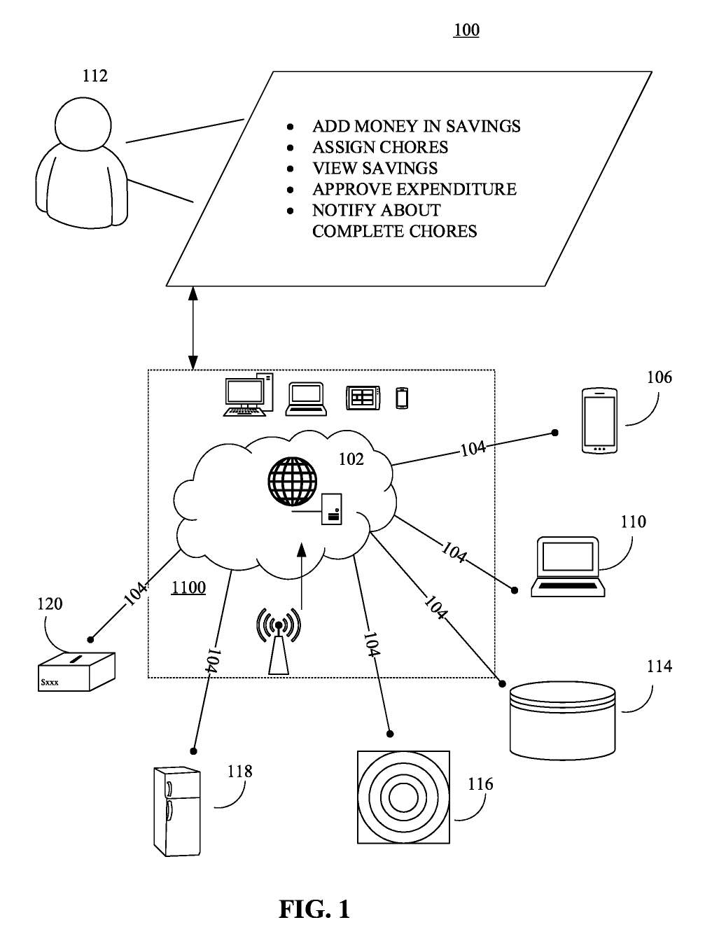

FIG. 1 is an illustration of an online platform 100 consistent with various embodiments of the present disclosure. By way of non-limiting example, the online platform 100 for facilitating savings of money based on Chores and/or periodic allowances may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (databases like but not limited to bank servers), sensors, IOT devices 118, (e.g. a coffee maker, a refrigerator and a dishwasher), Smart Money Boxes 120 (e.g. a safe-shaped money box, and a toy shaped money box) over a communication network 104, such as, but not limited to, the Internet. Further, users of the platform may include relevant parties such as, but not limited to, parents, children and other individuals. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1100.

According to some embodiments, the online platform 100 may be configured to communicate with a system to facilitate savings of money based on chores and/or a periodic allowance. The system may include a Smart Money Box. In an instance, the Smart Money Box may include a digital touch interface and may be paired with a mobile communication device that may have a companion application installed on it.

The system may allow users to register and create user profiles on the online platform 100. For instance, the user profiles created may include parent profiles, and child profiles linked with parent profiles. Further, the created child profile may be connected to the respective Smart Money Box. The system may also include a companion application that may be controlled by parents using one or more user devices, including smartphones and computers.

In further embodiments, the system may also allow parents to create and manage a list of chores through the companion application which may be accessed through a computer or a handheld device.

In further embodiments, the system may allow linking of an existing bank account to the user profiles. Accordingly, a bank account associated with the child profile may be linked to the Smart Money Box. Accordingly, information such as amount of savings in the bank account may be visible on the Smart Money Box. In some embodiments, the account may be in the parent's name, and may list the child as a beneficiary. In other embodiments, the bank account may belong to the child. Further, the system may also allow the creation of new accounts for savings and spending through third party financial services. The system may allow parents to send money to the bank account associated with the child. The companion application may be used to transfer funds to the bank account linked to the Smart Money Box.

In further embodiments, the Smart Money Box may also contain a slot to insert and store physical currency. Additionally, the Smart Money Box may also include sensors to count the amount of currency that may have been stored in it. For example, the sensors may include image detectors configured to capture an image of a physical currency and recognize a type of currency (e.g. US dollar, Euro etc.) and a denomination (5, 10, 20, etc.) of the currency based on analyzing the image. Alternatively, the sensors may include a weight sensor configured to identify a coin (i.e. monetary value) based on weight of the coin. Further, the Smart Money Box may determine a total sum of the amount of physical currency present in the Smart Money Box and the amount of money available in the bank account linked to the Smart Money Box. Subsequently, the total sum may be displayed on the digital touch interface of the Smart Money Box.

In further embodiments, the system may allow the linking of external wallets for cryptocurrencies. Periodic allowances and monetary rewards earned for chores may be received in the form of cryptocurrencies to the wallets that may be linked to the child's profile.

In some embodiments, the system may be linked to an online wallet. The wallet may be accessed through the smart money box. The Smart Money Box may calculate the value of the cryptocurrency, and display total savings after adding the amount of physical currency stored in the smart money box.

Further, the smart money box may also have a mobile wallet for crypto currencies downloaded in it. A mobile wallet may be an application that may be downloaded directly to the Smart Money Box, and may be used to store, and transact in the desired cryptocurrencies. The cryptocurrencies may be sent to the wallet directly, and the savings balance may be reflected on the Smart Money Box.

Further, the system may also support hardware wallets that may be connected to the smart money box to access the savings. Hardware wallets may store the user's private keys on a hardware device and may use USB, or any other connection ports and mechanisms to connect the hardware device to the Smart Money Box.

Further, the system may allow transactions through cryptocurrencies to be completed directly through the smart money box. The smart money box may make transactions in cryptocurrencies to make payments to POS devices through NFC.

Further, to spend the savings, the system may further include an ATM/debit card associated with the bank account linked to the Smart Money Box. The ATM/Debit card may be used to withdraw cash from any ATM and may be used to directly purchase goods. However, in some embodiments, the child may need an approval for withdrawal. The child may then send a request to the companion app through the Smart Money Box and may be approved through the companion application. The child may be able to spend or withdraw only an approved amount of money from the savings through the ATM/debit card.

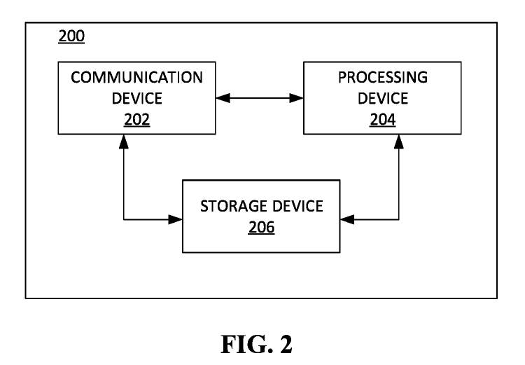

FIG. 2 shows a system 200 for facilitating management of chores. The system 200 may include a communication device 202 configured for receiving chore data corresponding to at least one chore from a parent device. Further, the communication device 202 may be configured for transmitting the chore data to a child device. Further, the communication device 202 may be configured for receiving operational data from at least one electrical appliance associated with the chore data. Further, the communication device 202 may be configured for transmitting chore status data corresponding to the at least one chore to the parent device. Further, the communication device 202 may be configured for transmitting account data corresponding to at least one child account to the child device. Further, the system 200 may include a processing device 204 configured for analyzing the chore data and the operational data. Further, the processing device 204 may be configured for generating the chore status data based on the analyzing. Further, the processing device 204 may be configured for determining at least one reward based on the chore status data. Further, the processing device 204 may be configured for updating the account data based on the at least one reward. Further, the system 200 may include a storage device 206 configured for storing the chore data, the chore status data and the account data.

In some embodiments, the at least one reward may include a monetary reward.

In some embodiments, the at least one reward may include a cryptocurrency token.

In some embodiments, the at least one child account may include a child bank account. Further, the communication device 202 may be configured for communicating with a banking server configured for hosting the child bank account. Further, updating the account data may include updating the child bank account.

In some embodiments, the communication device 202 may be further configured for transmitting the at least one reward to the parent device. Further, the parent device may be configured to perform a financial transaction between a parent bank account associated with the parent device and a child bank account associated with the child device.

In some embodiments, the chore data may correspond to a plurality of chores associated with a plurality of parent devices. Further, the communication device 202 may be configured for receiving a plurality of contextual data corresponding to the plurality of chores. Further, the communication device 202 may be configured for transmitting chore analytics to at least one parent device of the plurality of parent devices. Further, the processing device 204 may be configured for generating the chore analytics based on each of the chore data corresponding to the plurality of chores and the plurality of contextual data.

In some embodiments, the communication device 202 may be further configured for receiving a request for chore recommendation from the parent device. Further, the request may include subject contextual data corresponding to one or more of the parent device and the child device. Further, the communication device 202 may be configured for transmitting at least one chore recommendation to the parent device. Further, the processing device 204 may be configured for generating the at least one chore recommendation based on the chore analytics and the subject contextual data.

In some embodiments, the processing device 204 may be configured for generating the chore analytics based further on a plurality of rewards associated with the plurality of chores. Further, the at least one chore recommendation may include at least one reward recommendation.

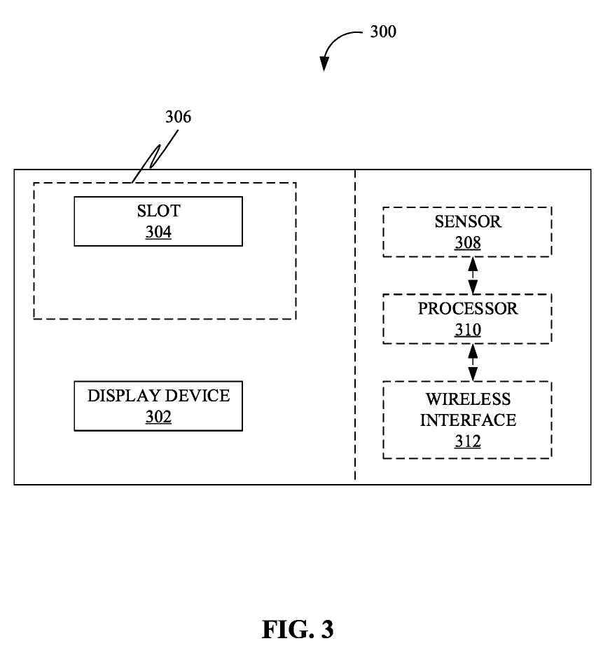

In some embodiments, as shown in FIG. 3, the child device may include a smart money box 300 which may include a display device 302 configured for displaying the chore data and the account data. Further, the smart money box 300 may include a slot 304 configured to receive one or more of a monetary coin and a monetary note. Further, the smart money box 300 may include a secured container 306 coupled with the slot 304. Further, the secured container 306 may be configured to securely house one or more of the monetary coin and the monetary note. Further, the smart money box 300 may include at least one sensor configured 308 for sensing at least one physical characteristic associated with one or more of the monetary coin and the monetary note. In some embodiments, the at least one physical characteristic may include one or more of a length, a width, a diameter, a thickness, a weight, a density, specific gravity, a color, a texture, a design, a pattern and indicia. Further, the smart money box 300 may include a processor 310 communicatively coupled to the at least one sensor 308. Further, the processor 310 may be configured to determine a monetary value of one or more of a monetary coin and a monetary note based on the at least one physical characteristic. Further, the smart money box 300 may include a wireless interface 312 communicatively coupled to the processor 310. Further, the wireless interface 312 may be configured for communicating with a network device.

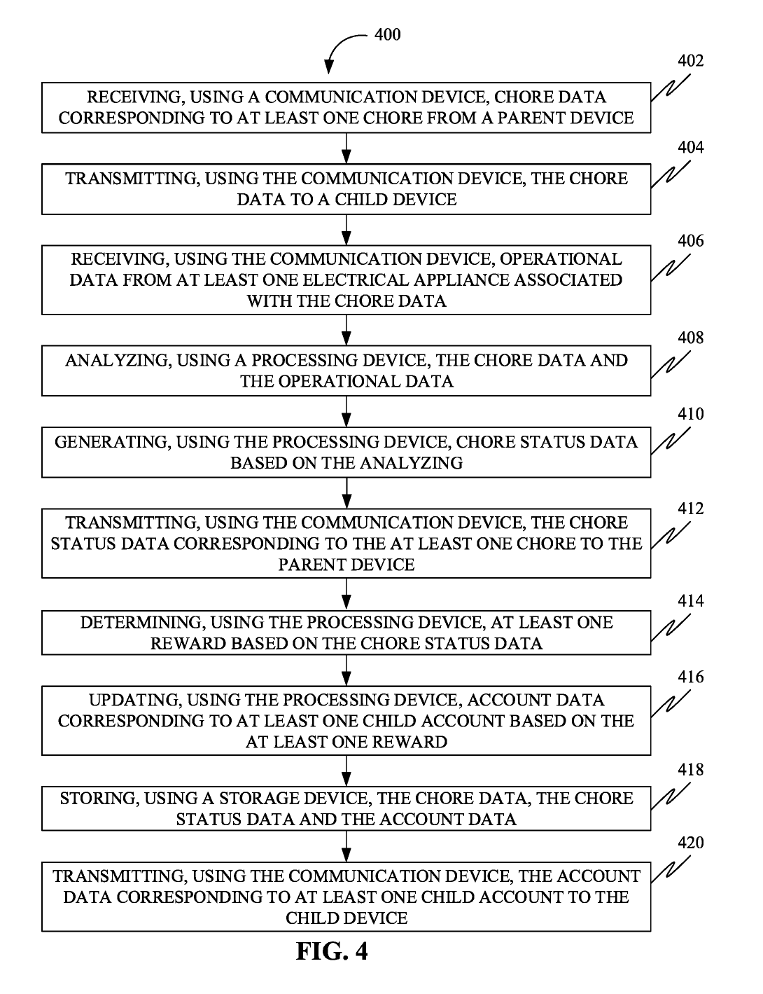

FIG. 4 shows a flowchart of a method 400 for facilitating management of chores. At 402, the method 400 may include receiving, using a communication device, chore data corresponding to at least one chore from a parent device. Further, at 404, the method 400 may include transmitting, using the communication device, the chore data to a child device. Further, at 406, the method 400 may include receiving, using the communication device, operational data from at least one electrical appliance associated with the chore data. Further, at 408, the method 400 may include analyzing, using a processing device, the chore data and the operational data. Further, at 410, the method 400 may include generating, using the processing device, chore status data based on the analyzing. Further, at 412, the method 400 may include transmitting, using the communication device, the chore status data corresponding to the at least one chore to the parent device. Further, at 414, the method 400 may include determining, using the processing device, at least one reward based on the chore status data. In some embodiments, the at least one reward may include a monetary reward. In some embodiments, the at least one reward may include a cryptocurrency token. Further, at 416, the method 400 may include updating, using the processing device, account data corresponding to at least one child account based on the at least one reward. In some embodiments, the at least one child account may include a child bank account. Further, at 418, the method 400 may include storing, using a storage device, the chore data, the chore status data and the account data. Further, at 420, the method 400 may include transmitting, using the communication device, the account data corresponding to at least one child account to the child device. In some embodiments, the method 400 may further include transmitting, using the communication device, the at least one reward to the parent device. Further, the parent device may be configured to perform a financial transaction between a parent bank account associated with the parent device and a child bank account associated with the child device.

In some embodiments, the child device may include a smart money box, such as the smart money box 300.

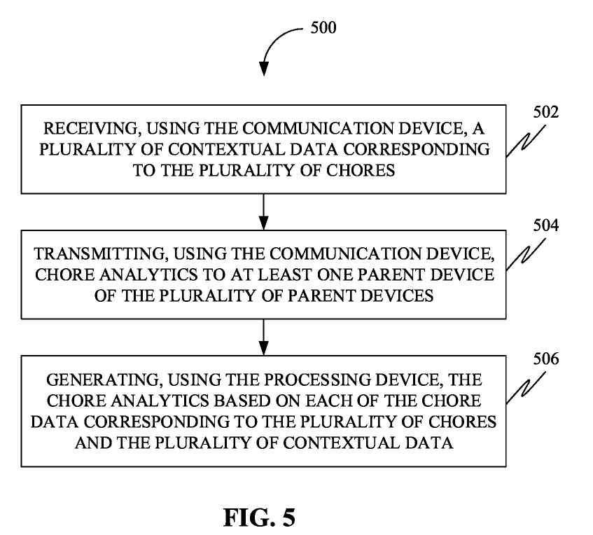

FIG. 5 shows a flowchart of a method 500 for generating chore analytics. In some embodiments, the chore data may correspond to a plurality of chores associated with a plurality of parent devices. Further, at 502, the method 500 may include receiving, using a communication device, a plurality of contextual data corresponding to the plurality of chores. Further, at 504, the method 500 may include generating, using a processing device, chore analytics based on each of the chore data corresponding to the plurality of chores and the plurality of contextual data. Further, at 206, the method 500 may include transmitting, using the communication device, the chore analytics to at least one parent device of the plurality of parent devices.

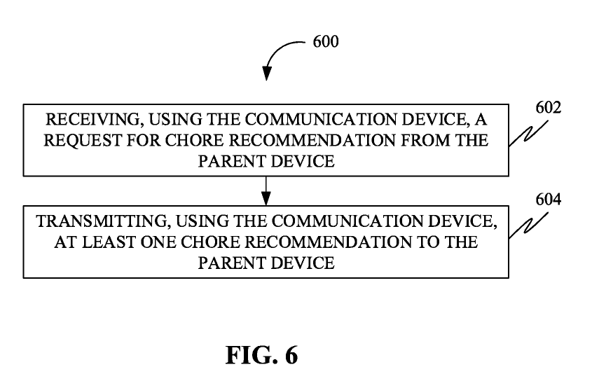

FIG. 6 shows a flowchart of a method 600 for transmitting a chore recommendation. At 602, the method 600 may include receiving, using a communication device, a request for chore recommendation from the parent device. Further, the request may include subject contextual data corresponding to one or more of the parent device and the child device. Further, at 604, the method 600 may include transmitting, using the communication device, at least one chore recommendation to the parent device. Further, the generating of the at least one chore recommendation may be based on the chore analytics and the subject contextual data. In some embodiments, the generating of the chore analytics may be based further on a plurality of rewards associated with the plurality of chores. Further, the at least one chore recommendation may include at least one reward recommendation.

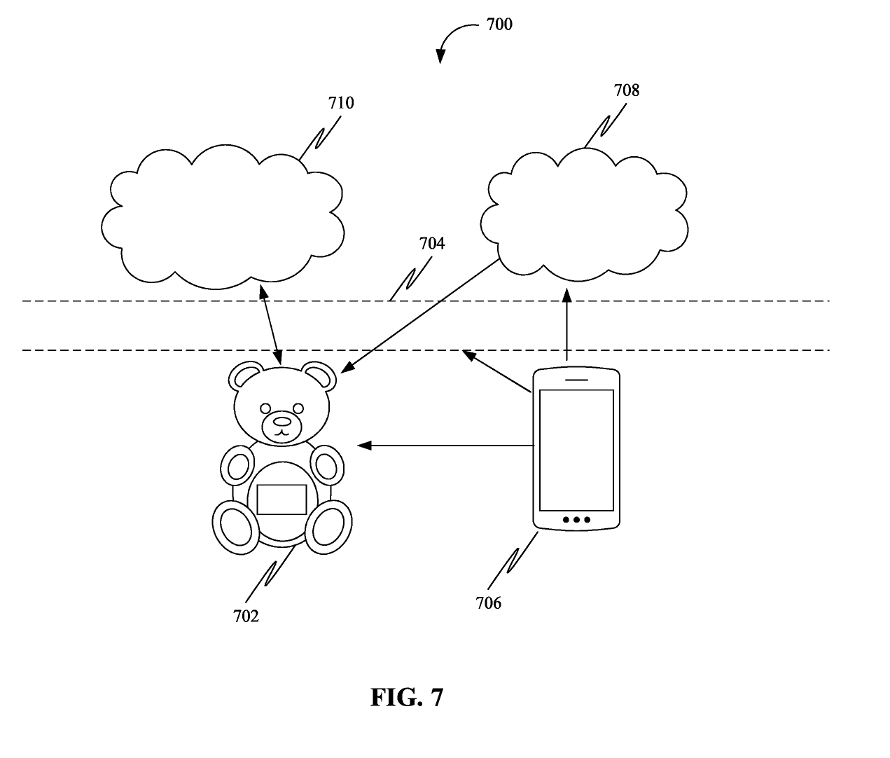

FIG. 7 shows an exemplary system 700 to facilitate savings of money based on chores and/or a periodic allowance. The system 700 may include a Smart Money Box 702 in the shape of a child's toy. The Smart Money Box 702 may include an incorporated audio/visual display and an interactive touch interface. The Smart Money Box 702 may also include a wireless communication to an online cloud platform 704 over a network, such as Wi-Fi, and may wirelessly connect to one or more user devices, such as a smartphone 706 over a communication network, such as Bluetooth. Further, the Smart Money Box 702 may be connected to a one or more external servers 708, such as bank servers through 3rd party API services or banking APIs. Accordingly, account information of a bank account as, such as a child bank account may be visible on the Smart Money Box 702. For instance, information such as the amount of savings in the bank account, recent transactions, etc., may be displayed on the digital touch interface of the Smart Money Box 702. Further, the system 700 may allow creation of new accounts for savings and spending through third party financial services. Further, the smartphone 706 may include an installed companion application that may allow a user of the system 700 to setup the Smart Money Box 702. Setup may include connecting the smartphone 706 to the Smart Money Box 702, setting up a network connection such as Wi-Fi on the Smart Money Box 702, and creating user profiles. The companion application may also be used to transfer funds to the bank account, such as the child bank account linked to the Smart Money Box 702, and view transactions made in the bank account. Further, to spend the savings, the bank account linked to the Smart Money Box 702 may include an associated ATM/debit card, which may be used to withdraw cash from any ATM and may be used to directly purchase goods. The companion application may also be used to approve and allocate funds to the ATM/debit card. Further, the companion application may be used for setting up a chores list for financial reward. The companion application may also be used for transferring a periodic allowance to the bank account linked with the Smart Money Box 702. The companion application may also be used for general interaction with a child using the Smart Money Box 702. The interaction may be in the form of messages, audio, video etc. Further, the system may communicate with a cloud database 710, herein referred to as GoSave Cloud services. The cloud database 710 may include one or more user profiles, a global chores and/or allowance database and a database of one or more Smart Money Boxes, including the Smart Money Box 702 connected to the cloud platform 710. The cloud database 710 may also include algorithms to suggest savings, allowances, and chores, based on big data collected from user profiles and/or the one or more Smart Money Boxes.

In further embodiments, the system 700 may also include a digital wallet. The digital wallet may be linked to a child profile, and may receive deposits directly. The Smart Money Box 702 may be the physical embodiment of the wallet and may be able to make and receive payments directly, for example, through NFC.

In further embodiments, the system 700 may also include a companion application for a child. The child may install the companion application on a user device, such as the smartphone 706, or a personal computer. The companion application may allow the child to access the complete functionality of the Smart Money Box 702 on the user device, such as the smartphone 706.

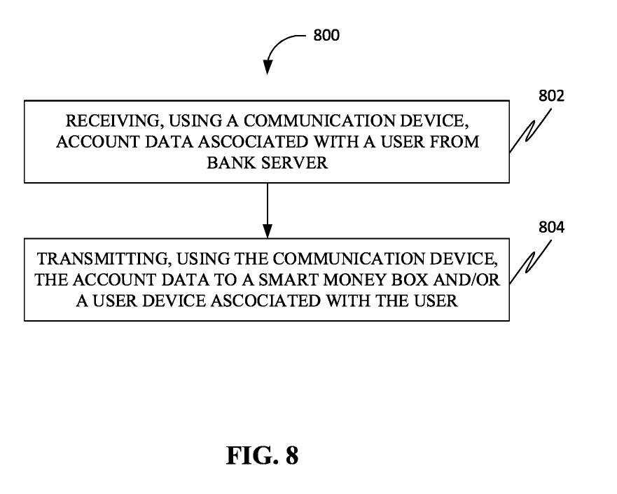

FIG. 8 shows a method 800 of facilitating savings of money based on chores and/or periodic allowances including receiving account data associated with a user from a bank server and transmitting the account data to a Smart Money Box, in accordance with some embodiments. Accordingly, at 802, the method 800 may include receiving account data associated with a user (e.g. child, parent etc.) from a bank server. The account data may be from any associated bank account in any bank in the world. The account data may include, for example, an account balance, log of recent transactions and a list of withdrawals and deposits.

Further, at 804, the method 800 may include a step of transmitting the account data to a Smart Money Box and/or a user device associated with the user. The user device may be, for example, a parent device and/or a child device. Further, the Smart Money Box may be configured to receive physical currency through a slot. The Smart Money Box may also house sensors that may allow the Smart Money Box to calculate the amount of money that may have been stored physically. Further, the Smart Money Box may calculate the sum of the physical currency, and the savings in the associated bank account, and may display the sum of the savings on a digital display of the Smart Money Box. Further, the Smart Money Box may also transmit this information to associated user devices, such as a parent device.

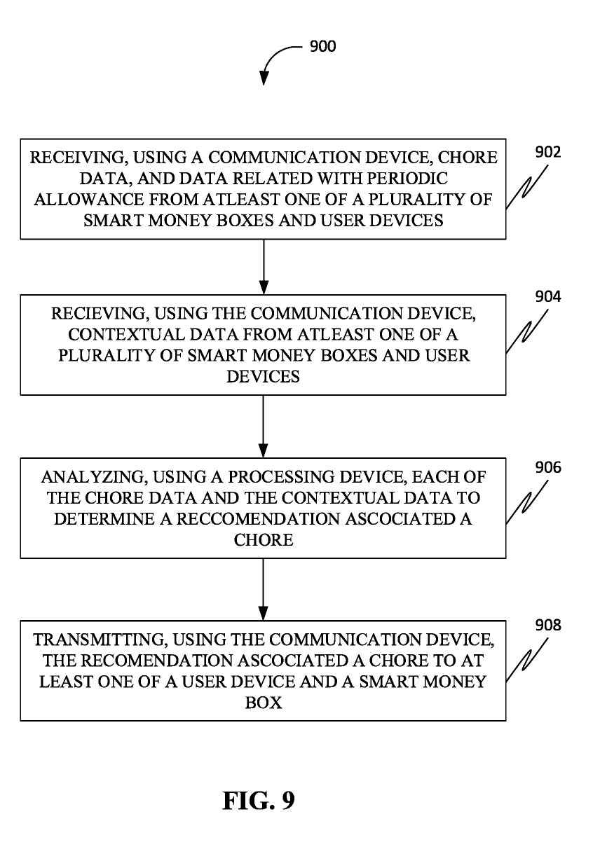

FIG. 9 shows a method 900 of facilitating savings of money based on chores and/or periodic allowance including recommending periodic allowance, chores and/or monetary rewards based on chore data received from at least one of a plurality of Smart Money Boxes and a plurality of user devices, in accordance with some embodiments. Accordingly, at 902, the method 900 may include receiving, using a communication device, chore data, and data related with periodic allowance from at least one of the plurality of Smart Money Boxes and user devices. Chore data may include information like description of a Chore, a time and/or duration associated with the chore, and a monetary reward associated with the chore. Data related with periodic allowances may include the amount of allowance, and the interval at which the allowance is transferred

Further, at 904, the method 900 may include receiving, using the communication device, contextual data from at least one of the plurality of Smart Money Boxes and user devices. The contextual data may include, but may not limited to, demographic data such as age, location, income, education level, occupation, etc.

Further, at 906, the method 900 may include analyzing, using a processing device, each of the chore data, allowance data, and the contextual data. For instance, the analyzing may include determining a distribution of specific chores against various demographic variables such as, for example, region, age, ethnicity, income level etc. Accordingly, based on the distribution, estimate a type of chore, a frequency of assigning a chore, a time and/or duration associated with the chore and a monetary reward associated with a chore based on one or more of demographic variables associated with a parent and/or a child may be estimated. Further, allowances assigned to users may also be analyzed against various demographic variables such as, for example, region, age, ethnicity, income level etc. In an instance, the analyzing may be based on details about the Smart Money Boxes, the associated chores and corresponding monetary rewards awarded in lieu of completion of chores. Accordingly, the an AI engine may be configured to perform machine learning on the allowance data, chore data and the contextual data. Further, the contextual data about the users who set the chores may also be analyzed.

Further, at 908, the method 900 may include transmitting, using the communication device, a recommendation associated with a chore to at least one of a user device (associated with a parent and/or a child) and a Smart Money Box. For instance, the recommendation may be sent to a parent device suggesting chores and/or parameters associated with the chore (e.g. time, duration, monetary reward etc.) to the parent based on corresponding contextual information. Further, the recommendation may also include tips to perform a chore. As an example, the analysis may include determining that parents assign the chore of getting a car serviced to children who may be above 15 years of age. Therefore, the chore of “getting the car serviced” may not be recommended to users whose child may be younger than 15 years. Further, a recommendation about the allowance may be sent. The recommendation may be based on the age, income level, or a combination of any of aforementioned factors. For example, the analysis may include determining that the allowance of teenagers is generally more than the allowances received by children in their pre-teenage years. Accordingly, an increase in allowance as the age of the child increases.

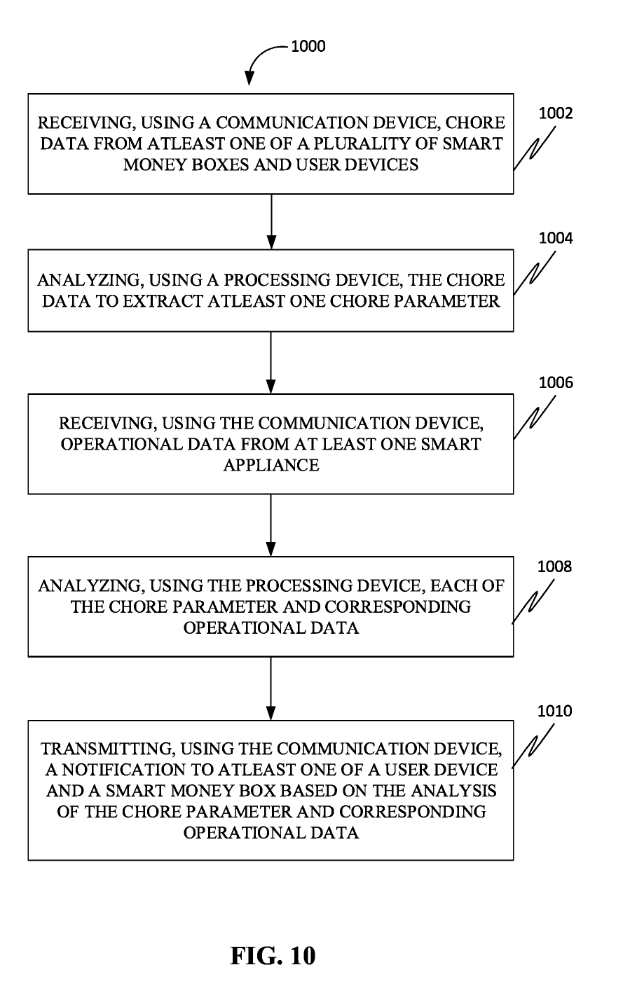

FIG. 10 shows a flowchart of a method 1000 of facilitating savings of money based on chores including sending a notification based on operational data received from smart appliances, in accordance with some embodiments. Accordingly, at 1002, the method 1000 may include receiving, using a communication device, chore data from at least one of the plurality of Smart Money Boxes and the plurality of user devices. Chore data may include a natural language description of one or more of a chore, a time and/or duration associated with the chore, and a monetary reward associated with the chore.

Further, at 1004, the method 1000 may include analyzing, using a processing device, the chore data to extract at least one chore parameter. For instance, the analyzing may include performing natural language processing to identify information such as a type of chore, a duration of the chore, a time at which the chore is to be performed, indication of one or more appliances to be operated in performing the chore and so on.

Further, at 1006, the method 1000 may include receiving, using the communication device, operational information from at least one smart appliance. The operational data may include information representation an operational state of the at least one smart appliance. For example, the operational data may include a time at which a smart appliance was turned ON and/or OFF and a duration for which the smart appliance was operated, settings of the smart appliance during operation, a location at which the smart appliance was operated, identity of a user who operates the smart appliance and so on.

Further, at 1008, the method may include analyzing, using the processing device, each of the chore parameter against the operational data received from the at least one smart appliance. Accordingly, in an instance, the analyzing may include determining whether a chore was completed by performing a comparative analysis of chore parameter and operational data. For instance, the analyzing may include determining that the chore of cleaning the dishes may have to be performed before a certain time on a certain day. Accordingly, operational data may be received from a dishwasher and analyzed to determine whether the dishwasher may have run for a needed duration at a certain time. If these conditions match, the chore may be determined to have been completed.

Further, at 1010, the method 1000 may include transmitting, using the communication device, a notification to at least one of a user device and a Smart Money Box based on the analyzing of Chore parameters against operational data. For example, a notification may be transmitted to a parent device notifying that the chore may have been completed. As another example, the notification may also include the operational data of the at least one smart appliance. Further, in some embodiments, the method may also include a step of transmitting a notification to a child device reminding the child to perform the chore.

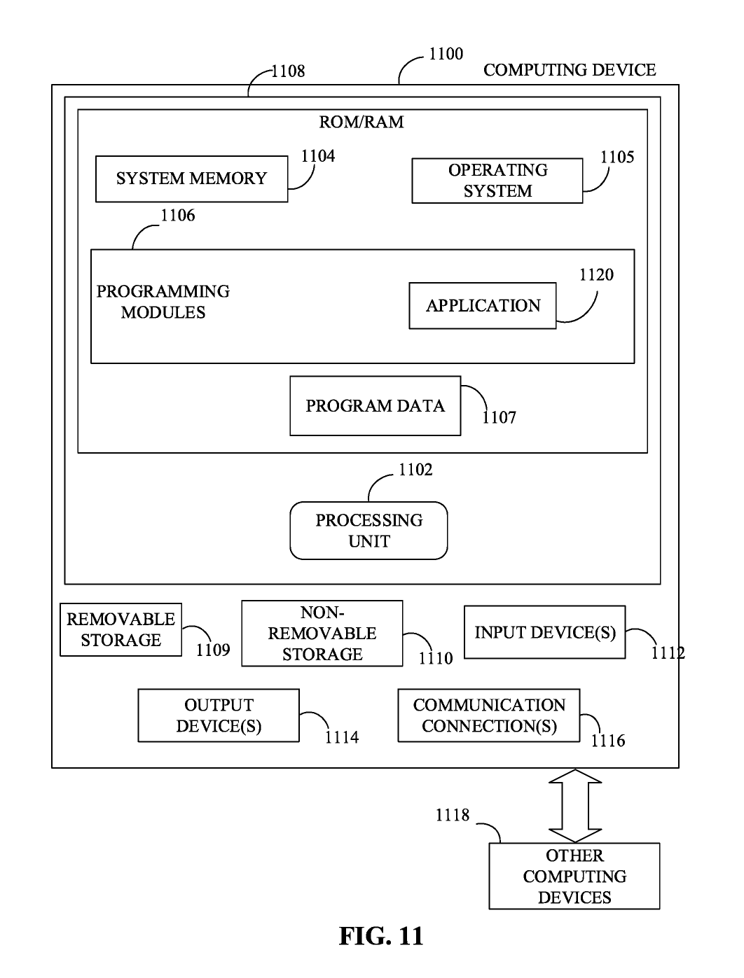

With reference to FIG. 11, a system consistent with an embodiment of the disclosure may include a computing device or cloud service, such as computing device 1100. In a basic configuration, computing device 1100 may include at least one processing unit 1102 and a system memory 1104. Depending on the configuration and type of computing device, system memory 1104 may comprise, but is not limited to, volatile (e.g. random-access memory (RAM)), non-volatile (e.g. read-only memory (ROM)), flash memory, or any combination. System memory 1104 may include operating system 1105, one or more programming modules 1106, and may include a program data 1107. Operating system 1105, for example, may be suitable for controlling computing device 1100's operation. In one embodiment, programming modules 506 may include image processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 11 by those components within a dashed line 1108.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 11 by a removable storage 1109 and a non-removable storage 610. Computer storage media may include volatile and nonvolatile, removable and non-removable media implemented in any method or technology for storage of information, such as computer-readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1100. Any such computer storage media may be part of device 1100. Computing device 1100 may also have input device(s) 1112 such as a keyboard, a mouse, a pen, a sound input device, a touch input device, a location sensor, a camera, a biometric sensor, etc. Output device(s) 1114 such as a display, speakers, a printer, etc. may also be included. The aforementioned devices are examples and others may be used.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1104, including operating system 1105. While executing on processing unit 1102, programming modules 1106 (e.g., application 1120 such as a media player) may perform processes including, for example, one or more stages of methods, algorithms, systems, applications, servers, databases as described above. The aforementioned process is an example, and processing unit 1102 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

The following is claimed:

1. A system for facilitating management of chores, the system comprising:
a communication device configured for:
receiving chore data corresponding to at least one chore from a parent device;
transmitting the chore data to a child device;
receiving operational data from at least one electrical appliance associated with the chore data;
transmitting chore status data corresponding to the at least one chore to the parent device;
transmitting account data corresponding to at least one child account to the child device;
a processing device configured for:
analyzing the chore data and the operational data;
generating the chore status data based on the analyzing;
determining at least one reward based on the chore status data;
updating the account data based on the at least one reward; and
a storage device configured for storing the chore data, the chore status data and the account data.

2. The system of claim 1, wherein the child device comprises a smart money box comprising:
a display device configured for displaying the chore data and the account data;
a slot configured to receive at least one of a monetary coin and a monetary note;
a secured container coupled with the slot, wherein the secured container is configured to securely house at least one of the monetary coin and the monetary note; and
at least one sensor configured for sensing at least one physical characteristic associated with at least one of the monetary coin and the monetary note;
a processor communicatively coupled to the at least one sensor, wherein the processor is configured to determine a monetary value of at least one of a monetary coin and a monetary note based on the at least one physical characteristic; and
a wireless interface communicatively coupled to the processor, wherein the wireless interface is configured for communicating with a network device.

3. The system of claim 2, wherein the at least one physical characteristic comprises at least one of a length, a width, a diameter, a thickness, a weight, a density, specific gravity, a color, a texture, a design, a pattern and indicia.

4. The system of claim 1, wherein the at least one reward comprises a monetary reward.

5. The system of claim 1, wherein the at least one reward comprises a cryptocurrency token.

6. The system of claim 1, wherein the at least one child account comprises a child bank account, wherein the communication device is configured for communicating with a banking server configured for hosting the child bank account, wherein updating the account data comprises updating the child bank account.

7. The system of claim 1, wherein the communication device is further configured for transmitting the at least one reward to the parent device, wherein the parent device is configured to perform a financial transaction between a parent bank account associated with the parent device and a child bank account associated with the child device.

8. The system of claim 1, wherein the chore data corresponds to a plurality of chores associated with a plurality of parent devices, wherein the communication device is further configured for:
receiving a plurality of contextual data corresponding to the plurality of chores; and
transmitting chore analytics to at least one parent device of the plurality of parent devices, wherein the processing device is further configured for generating the chore analytics based on each of the chore data corresponding to the plurality of chores and the plurality of contextual data.

9. The system of claim 1, wherein the communication device is further configured for:
receiving a request for chore recommendation from the parent device, wherein the request comprises subject contextual data corresponding to at least one of the parent device and the child device; and
transmitting at least one chore recommendation to the parent device, wherein the processing device is further configured for generating the at least one chore recommendation based on the chore analytics and the subject contextual data.

10. The system of claim 9, wherein the processing device is configured for generating the chore analytics based further on a plurality of rewards associated with the plurality of chores, wherein the at least one chore recommendation comprises at least one reward recommendation.

11. A method for facilitating management of chores, the method comprising:
receiving, using a communication device, chore data corresponding to at least one chore from a parent device;
transmitting, using the communication device, the chore data to a child device;
receiving, using the communication device, operational data from at least one electrical appliance associated with the chore data;
transmitting, using the communication device, chore status data corresponding to the at least one chore to the parent device;
transmitting, using the communication device, account data corresponding to at least one child account to the child device;
analyzing, using a processing device, the chore data and the operational data;
generating, using the processing device, the chore status data based on the analyzing;
determining, using the processing device, at least one reward based on the chore status data;
updating, using the processing device, the account data based on the at least one reward; and
storing, using a storage device, the chore data, the chore status data and the account data.

12. The method of claim 11, wherein the child device comprises a smart money box comprising:
a display device configured for displaying the chore data and the account data;
a slot configured to receive at least one of a monetary coin and a monetary note;
a secured container coupled with the slot, wherein the secured container is configured to securely house at least one of the monetary coin and the monetary note; and
at least one sensor configured for sensing at least one physical characteristic associated with at least one of the monetary coin and the monetary note;
a processor communicatively coupled to the at least one sensor, wherein the processor is configured to determine a monetary value of at least one of a monetary coin and a monetary note based on the at least one physical characteristic; and
a wireless interface communicatively coupled to the processor, wherein the wireless interface is configured for communicating with a network device.

13. The method of claim 12, wherein the at least one physical characteristic comprises at least one of a length, a width, a diameter, a thickness, a weight, a density, specific gravity, a color, a texture, a design, a pattern and indicia.

14. The method of claim 11, wherein the at least one reward comprises a monetary reward.

15. The method of claim 11, wherein the at least one reward comprises a cryptocurrency token.

16. The method of claim 11, wherein the at least one child account comprises a child bank account, wherein the method further comprises communicating, using the communication device, with a banking server configured for hosting the child bank account, wherein updating the account data comprises updating the child bank account.

17. The method of claim 11 further comprises transmitting, using the communication device, the at least one reward to the parent device, wherein the parent device is configured to perform a financial transaction between a parent bank account associated with the parent device and a child bank account associated with the child device.

18. The method of claim 11, wherein the chore data corresponds to a plurality of chores associated with a plurality of parent devices, wherein the method further comprises:
receiving, using the communication device, a plurality of contextual data corresponding to the plurality of chores; and
transmitting, using the communication device, chore analytics to at least one parent device of the plurality of parent devices; and
generating, using the processing device, the chore analytics based on each of the chore data corresponding to the plurality of chores and the plurality of contextual data.

19. The method of claim 11 further comprising:
receiving, using the communication device, a request for chore recommendation from the parent device, wherein the request comprises subject contextual data corresponding to at least one of the parent device and the child device; and
transmitting, using the communication device, at least one chore recommendation to the parent device, wherein the generating of the at least one chore recommendation is based on the chore analytics and the subject contextual data.

20. The method of claim 19, wherein the generating of the chore analytics is based further on a plurality of rewards associated with the plurality of chores, wherein the at least one chore recommendation comprises at least one reward recommendation.
